(19) United States
(12) Patent Application Publication
(10) Pub. No.: US 2004/0051764 A1
(43) Pub. Date: Mar. 18, 2004

(54) Easy install ink tank for an ink jet off-carrier system

(76) Inventors: Brian Dale Cook, Nicholasville, KY (US); Christopher W. Dicus, Indianapolis, IN (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/243,330

(22) Filed: Sep. 13, 2002

(51) Int. Cl. B41J 2/175

(52) U.S. Cl. 347/86

(57) ABSTRACT

An ink tank latching system includes a housing having an opening and at least one latching rod movably disposed across a portion of the opening.

### BACKGROUND OF THE INVENTION

1. Field of the Invention

The present invention relates to an ink jet printer, and, more particularly, to a method and apparatus for installing an ink tank in an ink jet printer.

2. Description of the Related Art

An ink jet printer includes a printhead having a plurality of nozzles arranged in the direction paper is fed. Connected to the ink jet nozzles is an ink delivery mechanism that supplies ink to the nozzles from an ink reservoir. Ink jet printers may have a single printhead containing an ink reservoir, which is replaced as an integral unit when the ink supply runs out. Some ink jet printheads have a combined set of colors contained in a single printhead. Another type of ink jet printer employs a printhead with a separate ink reservoir. The ink reservoir also known as an ink tank may be in constant fluid communication with the printhead or it may be in intermittent communication with the printhead.

Intermittent communication of the printhead with the ink tank allows a large supply of ink to be held in the ink tank with the printhead having a small reservoir of ink on board. When the printhead senses the need to replenish the ink in the on-board reservoir, it is positioned for refilling from the ink tank.

Constant fluid communication between the ink tank and the printhead is implemented either by a direct connection of the ink tank to the printhead or by way of flexible tubes.

Ink tanks in ink jet printers are replaced when an ink supply is diminished. Ink tanks are often compressed to interface with an ink conveyance mechanism for conveying the ink from the ink tank to the printhead.

A problem with inserting ink tanks is the amount of force necessary for the ink tank to come into fluid communication with fluid connectors.

What is needed in the art is a method and apparatus that reduces the effort needed to install an ink tank in an ink jet printer.

### SUMMARY OF THE INVENTION

The present invention provides an apparatus and method for easily installing an ink tank in an ink jet off-carrier printer.

The invention, in one form thereof is directed to an ink tank latching system including a housing having an opening and at least one latching rod movably disposed across a portion of the opening.

The invention, in another form thereof, relates to an ink jet printer having an ink tank for containing a supply of ink including at least one printhead support, at least one printhead moveably connected to the printhead support and at least one ink tank receiver in fluid communication with the at least one printhead. The ink tank receiver includes a housing having an opening for receiving the ink tank and at least one latching rod movably disposed across a portion of the opening.

The invention, in still another form thereof, relates to a method of installing an ink tank in an inkjet printer including the steps of opening an ink tank receiver access door, inserting an ink tank in the ink tank receiver and engaging the ink tank with a latching rod across a surface of the ink tank, the latching rod interactively connected to the access door.

An advantage of the present invention is that an ink tank can be easily installed in an ink jet printer.

Another advantage is that the access door provides a mechanical advantage for pressing the ink tank against fluid connectors.

A further advantage is that the access door is retained in a closed position by way of an over-center mechanism.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is an imaging system including an ink jet printer incorporating an embodiment of an ink tank receiver of the present invention;

FIG. 2 is a perspective view of the ink tank receiver used in the ink jet printer of FIG. 1;

FIG. 3 is a cross sectional side view of the ink tank receiver illustrated in FIGS. 1 and 2;

FIG. 4 is a cross sectional view showing the insertion of an ink tank in the ink tank receiver of FIGS. 1-3;

FIG. 5 is a cross sectional side view illustrating the ink tank being more fully inserted into the ink tank receiver of FIGS. 1-4; and

FIG. 6 is a cross sectional side view showing the ink tank fully inserted and the mechanism of the ink tank receiver of FIGS. 1-5, in an over-center latched position.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

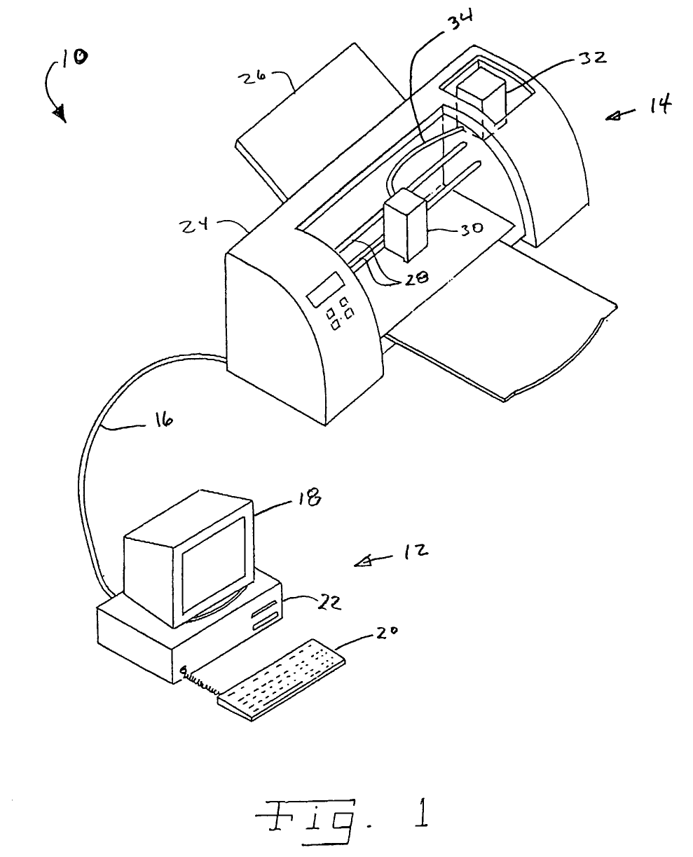

Referring now to the drawings and particularly to FIG. 1, there is shown a perspective view of an imaging system 10 including computer system 12, ink jet printer 14 and communication link 16. Computer system 12 is interconnected with ink jet printer 14 by way of communication link 16. Communication link 16 can be a point to point electrical cable connection between either serial or parallel ports of ink jet printer 14 and computer system 12 or the connection can be by way of a network connection such as an Ethernet network.

Computer system 12 includes a monitor 18, a keyboard 20 and a computer 22. Computer 22 includes application software operated by a user and provides image data representing an image to be printed and printing command data to ink jet printer 14 by way of communication link 16.

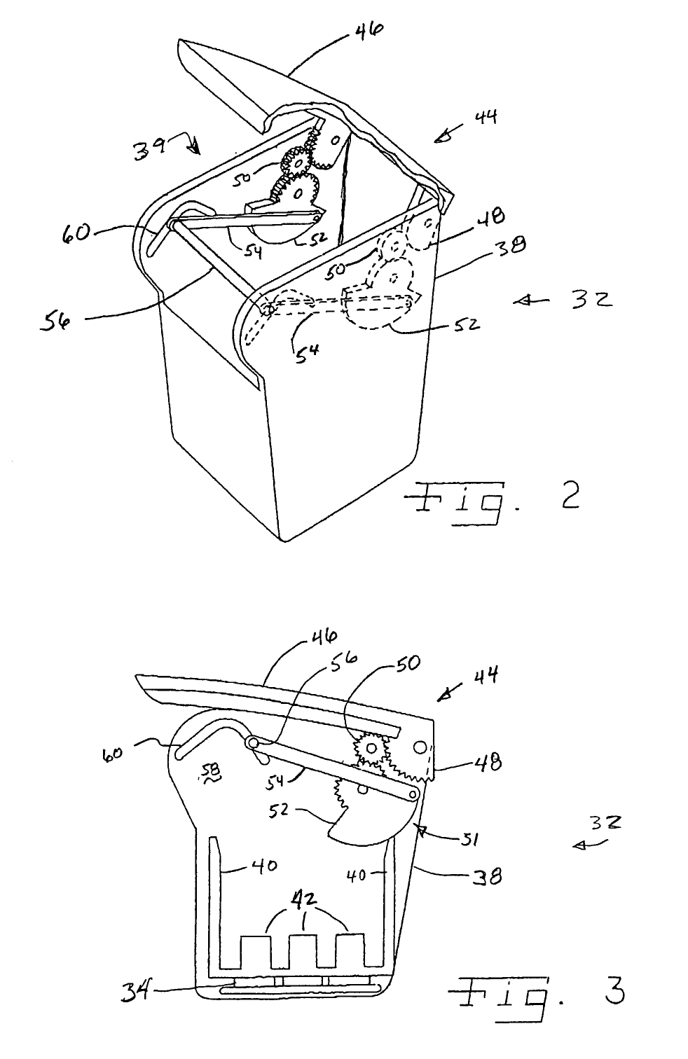

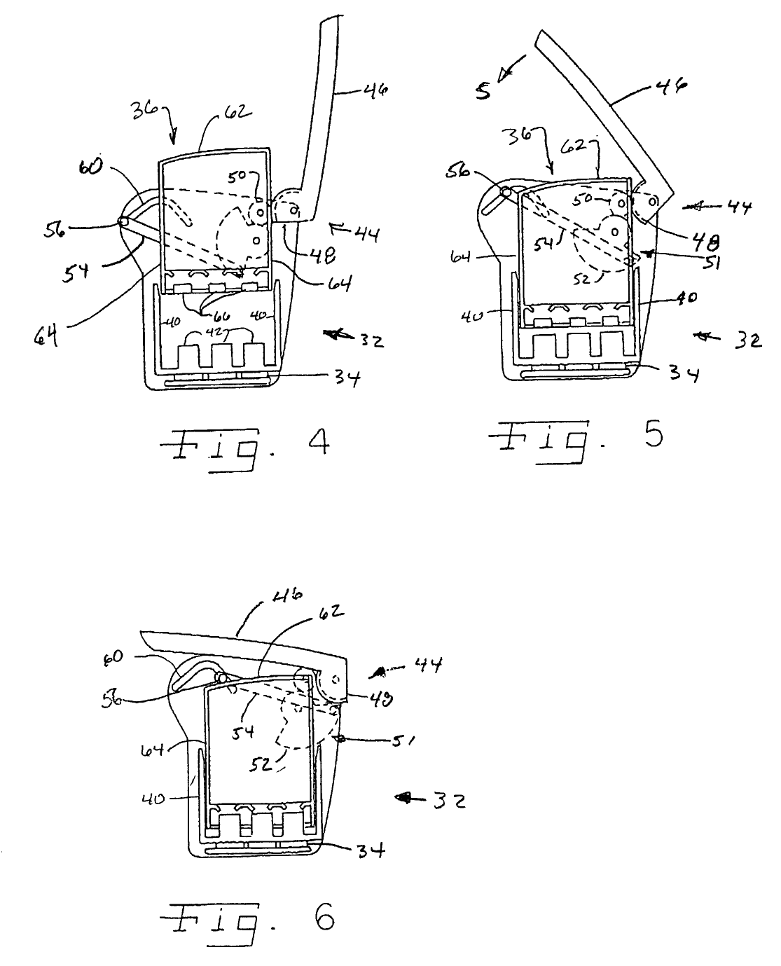

Now, additionally referring to FIGS. 2-6, there is shown ink jet printer 14 including printer housing 24, paper tray 26, printhead support 28, printhead 30, ink tank receiver 32, connection mechanism 34 and ink tank 36. Printer housing 24 includes the exterior shell of ink jet printer 14 that provides structural integrity and mounting points to the mechanisms contained within ink jet printer 14. Paper tray 26 is connected to printer housing 24 allowing for the feeding of paper into ink jet printer 14. Printhead support 28 is connected to printer housing 24 allowing for controllable movement of printhead 30 thereon. Printhead support 28 may consist of one or more cylindrical bars with an indexing feature either thereon or closely disposed thereby. Printhead 30, although shown as a single printhead, may be multiple printheads each for at least one color of ink. Printhead 30 has nozzles within a nozzle array. The nozzles may alternate in size along a vertical axis of printhead 30 and have a fixed vertical pitch of 1/600^{th} of an inch. Printhead 30 is in fluid communication with ink tank 36 that is contained in ink tank receiver 32.

Ink tank receiver 32 is interconnected with printhead 30 by way of connection mechanism 34. Ink tank 36 resides within ink tank receiver 32 having a supply of ink therein. Connection mechanism 34 includes parallel tubes, one tube for each color of ink contained in ink tank 36 that is supplied to printhead 30.

Alternatively, connector mechanism 34 may be implemented as an intermittent or on-demand type interaction between printhead 30 and ink tank receiver 32. Printhead 30 senses the need to increase the amount of ink in an on-board reservoir and then is positioned proximate to ink tank receiver 32 for a transfer of ink from ink tank 36 to printhead 30.

Ink tank receiver 32 includes receiver housing 38, ink tank guides 40, ink tank fluid connectors 42 and latching mechanism 44. Receiver housing 38 has an opening 39 on one end to accommodate the insertion of ink tank 36 therein. Receiver housing 38 provides structural integrity and mounting points for latching mechanism 44, ink tank guides 40, and ink tank fluid connectors 42. Ink tank guide 40 is positioned within receiver housing 38 having guiding protrusions, which interact with recesses and/or protrusions on ink tank 36 to key and properly guide ink tank 36 to ink tank fluid connectors 42. Ink tank fluid connectors 42 are positioned along a bottom portion of receiver housing 38 to accommodate septum positioned along the bottom of ink tank 36. The septum on ink tank 36 come into contact with ink tank fluid connectors 42 thereby facilitating the flow of ink from ink tank 36 into connection mechanism 34 and on to printhead 30.

Latching mechanism 44 includes access door 46, sector gears 48, idler gears 50, over-center mechanisms 51, latching rod 56, side plates 58 and guide slots 60.

Access door 46 is hingedly connected to housing 38 along one top side edge of housing 38. Access door 46 opens sufficiently to allow the passage of ink tank 36 into and out of receiver housing 38. Sector gears 48 may be integral with access door 46 or attached thereto. Sector gears 48 provides a transfer of mechanical movement of access door 46 to idler gears 50. As sector gears 48 rotate the teeth thereof engage corresponding teeth on idler gears 50, thereby transferring mechanical motion and reversing the direction of the motion to a corresponding over-center mechanism 51.

Over-center mechanism 51 includes an over-center disk gear 52 and a rod linkage 54. Over-center disk gear 52 is rotatably attached to housing 38 and pivotally attached to one end of rod linkage 54. Teeth on a portion of over-center disk gear 52 are engaged by the teeth of a corresponding idler gear 50. Rod linkage 54 has an other end connected to latching rod 56. A sector gear 48, an idler gear 50 and an over-center mechanism 51 are positioned on each side of housing 38 in a mirror image fashion. The positioning of gears 48, 50 and 52 and linkage 54 on each side of housing 38 allow for the insertion of ink tank 36 therebetween. The attachment of access door 46 to sector gears 48 and the interaction of idler gears 50 and over-center mechanisms 51 to latching rod 56 allow a uniform pressure to be applied to ink tank 36.

Latching rod 56 is connected near each end by a corresponding rod linkage 54 and latching rod 56 extends somewhat beyond the connection with each rod linkage 54 into a corresponding guide slot 60 on each side of housing 38. Rod linkage 54 traverses guide slot 60 along the path of slot 60 as latching mechanism 44 is moved from a latched position to an unlatched position. The coordinated movement of each rod linkage 54 causes latching rod 56 to move in a uniform manner along guide slot 60.

Guide slot 60 is formed as a part of side plate 58, which is attached to housing 38. Alternatively guide slot 60 may be integral with housing 38. Guide slot 60 is shaped to position latching rod 56 toward a side of housing 38 when access door 46 is an open position, thereby allowing ink tank 36 to be inserted without interference from latching rod 56. As latching mechanism 44 is moved to a latched position, latching rod 56 travels along guide slot 60 in a motion which allows engagement of latching rod 56 with ink tank 36 and to thereby apply pressure upon the top of ink tank 36 as latching mechanism 44 is moved to a latched position.

Referring to FIGS. 4-6, there is shown the insertion of ink tank 36 into ink tank receiver 32. Ink tank 36 includes an ink tank top surface 62, an ink tank guide interface 64 and ink tank septum 66. As shown in FIG. 4 access door 46 is in a fully open position with gears 48, 50 and 52 so positioned as to extend rod linkages 54, thereby causing latching rod 56 to be disposed toward an edge of ink tank receiver 32. The positioning of latching rod 56 along an edge of ink tank receiver 32 clears opening 39 for the insertion of ink tank 36. Ink tank 36 is initially inserted by an operator and ink tank guide interfaces 64 interact with ink tank guides 40 to properly orient and position ink tank 36 for engagement with ink tank fluid connectors 42.

Once ink tank 36 is positioned within ink tank receiver 32 and ink tank guide interfaces 64 have interacted with ink tank guides 40, access door 46 is moved in a closing motion, in the direction of arrow S. The action of closing access door 46 causes gears 48, 50 and 52 to rotate pulling rod linkage 54, thereby moving latching rod 56 toward a point of engagement with ink tank top surface 62. As shown in FIG. 6 access door 46 is in a closed or nearly closed position having caused ink tank septum 66 of ink tank 36 to engage ink tank fluid connectors 42 along the bottom of ink tank receiver housing 38. Latching rod 56 presses against top surface 62 of ink tank 36 pushing ink tank septum 66 into fluid communication with ink tank fluid connectors 42. When access door 46 is in a closed latched position, rod linkages 54 become over-centered relative to the pivoting point of over-center disk gear 52 as shown in FIG. 6. Rod linkages 54 (see FIG. 6) are above the pivot point for over-center disk gear 52. Over-centering mechanism 51 allows for a latched position to be maintained utilizing the pressure against the top surface 62 of ink tank 36 by latching rod 56 to hold rod linkage 54 in the over-center position. While over-center mechanism 51 is in an over-center position force is transmitted by way of gears 48, 50 and 52 to access door 46, thereby retaining access door 46 in a closed position.

To remove ink tank 36 from ink tank receiver 32 access door 46 is lifted thereby relieving pressure from ink tank top surface 62 that has been applied by latching rod 56. As access door 46 is moved to an unlatched position, gears 48, 50 and 52 cause latching rod 56 to move to the side of housing 38. As pressure to ink tank 36 is removed the resilient nature of ink tank fluid connectors 42 cause ink tank 36 to move away from the bottom of ink tank receiver 32 allowing ink tank 36 to be grasped by an operator and thereby removed from ink tank receiver 32.

Although one ink tank receiver 32 has been illustrated in the drawings and is described herein, multiple ink tank receivers 32 may be employed in ink jet printer 14.

Latching mechanism 44 provides a mechanical advantage relative to the insertion force required to install ink tank 36 into ink tank receiver 32. The mechanical advantage allows an easy insertion of ink tank 36 and a positive connection of ink tank septum 66 with ink tank fluid connectors 42.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An ink tank latching system, comprising:
a housing having an opening; and
at least one latching rod movably disposed across a portion of said opening.

2. The system of claim 1, further comprising an access door connectively linked to said at least one latching rod.

3. The system of claim 1, further comprising at least one over-center mechanism connected to a corresponding one of said at least one latching rod.

4. The system of claim 3, wherein each said over-center mechanism includes: an
over-center disk gear rotatably connected to said housing; and
a rod linkage having a first end and a second end, said first end pivotally connected to said over-center disk, said second end connected to an end of at least one said latching rod.

5. The system of claim 4, wherein said over-center disk gear is configured to rotate until said rod linkage passes the center of said over-center disk gear.

6. The system of claim 1, wherein said housing includes at least one guide slot integral with at least one of at least one side of said housing and at least one side plate attached to said at least one side of said housing.

7. The system of claim 6, wherein said at least one guide slot includes a first guide slot and a second guide slot, said first guide slot disposed on a first side of said housing, said second guide slot disposed on a second side of said housing, said first side being arranged opposite to said second side.

8. The system of claim 7, wherein said at least one latching rod is one latching rod having a first end and a second end, said first end slidingly disposed in said first guide slot, said second end slidingly disposed in said second guide slot.

9. The system of claim 8, further comprising:
a first rod linkage pivotally connected to said first end;
a second rod linkage pivotally connected to said second end; and
an access door hingedly connected to said housing, said access door linked to said first rod linkage and said second rod linkage.

10. The system of claim 9, further comprising a plurality of gears linking said access door to said first rod linkage and said second rod linkage.

11. The system of claim 10, wherein said plurality of gears include at least one sector gear being one of integral with said access door and attached to said access door.

12. The system of claim 10, wherein said plurality of gears include at least one over-center disk gear pivotally connected with at least one of said first rod linkage and said second rod linkage.

13. The system of claim 12, wherein said at least one over-center disk gear has at least two positions including an over-center latched position and an unlatched position, said latching rod providing insertion pressure on an ink tank as said over-center disk gear is moved from said unlatched position to said over-center latched position.

14. An ink jet printer having an ink tank for containing a supply of ink, comprising:
at least one printhead support;
at least one printhead moveably connected to said printhead support;
at least one ink tank receiver in fluid communication with said at least one printhead, wherein said ink tank receiver, comprises:
a housing having an opening for receiving said ink tank; and
at least one latching rod movably disposed across a portion of said opening.

15. The printer of claim 14, wherein said fluid communication between said ink tank receiver and said printhead is one of continuous, intermittent and on demand.

16. The printer of claim 14, wherein said ink tank receiver further comprises an access door connectively linked to said at least one latching rod.

17. The printer of claim 14, wherein said ink tank receiver further comprises at least one over-center mechanism connected to a corresponding one of said at least one latching rod.

18. The printer of claim 17, wherein each said over-center mechanism includes:
an over-center disk gear rotatably connected to said housing; and
a rod linkage having a first end and a second end, said first end pivotally connected to said over-center disk, said second end connected to an end of at least one said latching rod.

19. The printer of claim 18, wherein said over-center disk gear is configured to rotate until said rod linkage passes the center of said over-center disk gear.

20. The printer of claim 14, wherein said housing includes at least one guide slot integral with at least one of at least one side of said housing and at least one side plate attached to said at least one side of said housing.

21. The printer of claim 20, wherein said at least one guide slot includes a first guide slot and a second guide slot, said first guide slot disposed on a first side of said housing, said second guide slot disposed on a second side of said housing, said first side being arranged opposite to said second side.

22. The printer of claim 21, wherein said at least one latching rod is one latching rod having a first end and a second end, said first end slidingly disposed in said first guide slot, said second end slidingly disposed in said second guide slot.

23. The printer of claim 22, wherein said ink tank receiver further comprises:
a first rod linkage pivotally connected to said first end;
a second rod linkage pivotally connected to said second end; and
an access door hingedly connected to said housing, said access door linked to said first rod linkage and said second rod linkage.

24. The printer of claim 23, wherein said ink tank receiver further comprises a plurality of gears linking said access door to said first rod linkage and said second rod linkage.

25. The printer of claim 24, wherein said plurality of gears include at least one sector gear being one of integral with said access door and attached to said access door.

26. The printer of claim 24, wherein said plurality of gears include at least one over-center disk gear pivotally connected with at least one of said first rod linkage and said second rod linkage.

27. The printer of claim 26, wherein said at least one over-center disk gear has at least two positions including an over-center latched position and an unlatched position, said latching rod providing insertion pressure on an ink tank as said over-center disk gear is moved from said unlatched position to said over-center latched position.

28. A method of installing an ink tank in an inkjet printer, comprising the steps of:
opening an access door of an ink tank receiver;
inserting an ink tank in said ink tank receiver; and
engaging said ink tank with a latching rod across a surface of said ink tank, said latching rod interactively connected to said access door.

29. The method of claim 28, further comprising the additional step of orienting ink tank guide interfaces with ink tank guides, said ink tank guide interfaces located along at least one side of said ink tank, said ink tank guides positioned in said ink tank receiver.

30. The method of claim 28, further comprising the additional step of closing said access door thereby causing said latching rod to move.

31. The method of claim 30, wherein said closing step further comprises the step of guiding said latching rod along at least one slot, each said slot located one of proximate to a side of said ink tank receiver and integral with a side of said ink tank receiver.

32. The method of claim 28, further comprising the additional step of positioning a rod linkage in an over-center orientation, said rod linkage having a first end and a second end, said first end connected to said latching rod, said second end pivotally connected to an over-center disk gear.
